(19) United States
(12) Patent Application Publication
(10) Pub. No.: US 2017/0244283 A1
(43) Pub. Date: Aug. 24, 2017

(54) Wirelessly Addressed and Powered Distributed Device Arrays

(71) Applicant: Photonica, Inc., Beverly Hills, CA (US)

(72) Inventor: Sutherland Cook Ellwood, JR., Cookham (GB)

(73) Assignee: Photonica, Inc., Beverly Hills, CA (US)

(21) Appl. No.: 15/282,862

(22) Filed: Sep. 30, 2016

Related U.S. Application Data
(60) Provisional application No. 62/234,942, filed on Sep. 30, 2015.

(51) Int. Cl. H02J 50/12; G06K 19/07; H02J 50/50; H02J 50/80; H02J 7/02; H02J 50/20

(52) U.S. Cl. CPC H02J 50/12; H02J 7/025; H02J 50/20; H02J 50/50; H02J 50/80; G06K 19/0708

(57) ABSTRACT

A system and method for scaling distributed device arrays, which include displays and sensor arrays improving the performance of arrays of virtually all sizes by combining wireless addressing and powering of functional devices including individual array elements or sub-sectors, groups, or collections of array elements using tap couplers distributed in a wireless relay system.

### CROSS REFERENCE TO RELATED APPLICATIONS

This application claims benefit of U.S. Patent Application No. 62/234,942 filed 30 Sep. 2015, the contents of which are hereby expressly incorporated by reference thereto in its entirety for all purposes.

### FIELD OF THE INVENTION

The present invention relates generally to the addressing and powering of devices and systems, especially functional devices arranged in arrays, groups, sets, assemblies, subassemblies, and collections, and more specifically, but not exclusively, to the addressing and powering of display systems, sensing systems, computational systems, and other device array systems, whether in compact or more spatially-separated groups, sets, assemblies, subassemblies, and collections with one or both of addressing and powering is performed, at least in part, wirelessly to each functional device.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the field of displays and sensor arrays (and distributed computing employing spatially separated arrays of simple micro-processors), there are several practical challenges to scaling to ever larger arrays by area. Chief among those are: increased power requirements and thermal loads due to increased resistance of ever-longer rows and columns, cost of manufacture, and the sheer weight and bulkiness of the addressing and power circuitry. Physical scaling of arrays and increasing resistance also creates challenges in maintaining switching speeds of array elements.

As display and sensor arrays scale up by total area, total information processing requirements for the overall array typically increases as well. This is necessary to either adequately maintain unit-area resolution for display arrays, or to maintain sensing capture density. For instance, when the same display resolution is spread over a larger area, a viewer must move further away from the display to maintain the same apparent resolution. Taken to a limit, when the resolution of a displayed image stays constant while the area increases, individual display elements will not only become noticeable to a viewer positioned within a given room, but the image at a certain point will break down and disappear.

Increasing sensor arrays by area, but with the same number of sensor nodes, reduces information capture density, which in most cases defeats the purpose of scaling a distributed sensor array in the first place.

Increasing information processing requirements means, for displays, a much larger overall resolution that must be supported by a central video processing capability, and a much larger overall power and addressing circuit, in terms of nodes or elements. Thus, scaling of arrays by area, which at a minimum adds gross length to current-carrying rows and columns, is not typically mitigated by reducing the density of addressed elements per area (which would be implied by keeping the overall resolution or sensor capture node totals constant).

Instead, resistance is increased by the greater total length of the conductive addressing elements AND by the increased number of nodes or elements addressed in a circuit-series.

In the field of displays, neither gas plasma or liquid crystal nor LED or OLED display technologies are inherently immune from the existing challenges of scaling up of power and addressing circuitry. The same is true of electro-magnetic or acoustic sensor arrays, or an array of simple microprocessors.

From the foregoing challenges, and others known to the art, it is apparent that solutions are needed to support the continued need to scale by area distributed device arrays of all kinds, and to improve the performance and reduce the cost, weight, heat emission, and power consumption of current arrays of all sizes.

What is needed is a system and method for addressing and powering devices, especially in arrays, collections and groups that eliminates or significantly reduces the use, and thus the related costs, both of manufacture and operation, of addressing and powering those arrays, collections, and groups through wired or continuously and physically connected material connections.

### BRIEF SUMMARY OF THE INVENTION

Disclosed is a system and method for scaling distributed device arrays, which include displays and sensor arrays. Embodiments of the present invention may improve the performance of arrays of virtually all sizes by combining wireless addressing and powering of individual array elements or sub-sectors, groups, or collections of array elements.

The following summary of the invention is provided to facilitate an understanding of some of technical features related to wireless power and/or wireless addressing of large scale collections of functional devices, and is not intended to be a full description of the present invention. A full appreciation of the various aspects of the invention can be gained by taking the entire specification, claims, drawings, and abstract as a whole. The present invention is applicable to other power and addressing systems as well as other energy dissipating systems and methods.

A solution to scaling distributed device arrays, including displays and sensor arrays, is proposed, which also improves the performance of arrays of virtually all sizes, which combines one or both of wireless addressing and wireless powering of individual array elements or sub-sectors, groups, or collections of array functional elements. Functional elements may be one-way or two-way. In some applications, it may be the case that a hybrid system includes a wired addressing system or a wired power system with some advantages achieved by including some wireless powering or addressing as the case may be. One-way and two-way systems and methods having N number of functional devices may include an energy source in a first “stage” directly coupled to all N functional devices as the last “stage” of the embodiment. In other embodiments, one or more intermediate stages may be included between the first and last stages to provide a “fan out” of energy and/or addressing distribution. In one-way or two-way implementations, some embodiments may include one or more of the functional devices as distribution hubs for wired/wired distribution of energy and/or addressing.

There are different mechanisms for wireless energy transfer, some of which are described in the incorporated patent application. Different portions of an implementation may combine differing wireless energy transfer mechanisms. For example, “bulk” wireless transfer may be better done in some cases using Q-coupled resonators to provide operating power and radiofrequency wireless transfer for addressing.

A hybrid radiofrequency identification (RFID) solution may be incorporated in some embodiments of the present invention. Traditionally RFID has been classified as passive or active. A passive RFID relies on RF energy transferred from a reader to a tag to power a tag. Active RFID uses an internal power source (i.e., a battery) with the tag to continuously power the tag and associated RF communication system. Hybrid RFID selectively, or continuously, provides power to the tag using wireless energy transfer as the power source. As noted herein and in the incorporated patent applications, the wireless energy transfer may be switchable, hence there would be a mechanism to control the hybrid RFID. Some configurations allow the hybrid RFID to sometimes function as a passive RFID system and sometimes as an active RFID system (with an advantage that the battery would never have to be replaced). Not requiring battery replacement can be very important, particularly for very large numbers of functional devices in a functional array.

A wireless energy transfer system for transferring energy from an energy source to an energy drain, including a wireless relay including a plurality of serially coupled wireless transmission segments defining a set of interfaces between pairs of the wireless transmission segments and a coupler disposed at each the interface of the set of interfaces, wherein each the coupler includes a begin energy transfer node having a begin wireless transfer coupling value, an end energy transfer node having an end wireless transfer coupling value different from the begin wireless transfer coupling value configured to be non-interactive within a predetermined level of wireless transfer performance with the begin wireless transfer coupling value, and a regenerator coupled to both the nodes, wherein the set of interfaces includes two or more interfaces, and wherein at least one of the couplers includes a first tap coupler having a first controllable energy access, the first tap coupler diverting energy from the regenerator to the first controllable energy access responsive to a first control data signal.

A method for transferring wirelessly energy from an energy source to an energy drain, including a) energizing a first set of begin energy transfer nodes, each the begin energy transfer node including a begin wireless transfer coupling value; b) energizing, responsive to the energization of the first set of begin energy transfer nodes, a first set of end energy transfer nodes, each the end energy transfer node having an end wireless transfer coupling value wherein each particular single one energized end energy transfer node is energized by a single one energized begin energy transfer node having a begin wireless transfer coupling value matching the end wireless transfer coupling value of the particular single one energized end energy transfer node within an interaction range; c) transferring energy from the energy source coupled to a specific begin energy transfer node to the energy drain coupled to a specific end energy transfer node; wherein the wireless relay includes a set of a plurality of energized begin energy transfer nodes within the interaction range of each the energized end energy transfer nodes with all energized begin energy transfer nodes other than the single one energized begin energy transfer node of the set of the plurality of energized begin energy transfer nodes each having a begin wireless transfer coupling value different from the begin wireless transfer coupling value of the single one energized begin energy transfer node; and wherein the wireless relay includes a set of a plurality of energized end energy transfer nodes within the interaction range of each the energized begin energy transfer nodes with all energized energy transfer nodes other than the single one energized end energy transfer node of the set of the plurality of energized end energy transfer nodes each having an end wireless transfer coupling value different from the end wireless transfer coupling value of the single one energized end energy transfer node; and wherein at least one of the couplers includes a first tap coupler having a first controllable energy access, the first tap coupler diverting energy from the regenerator to the first controllable energy access responsive to a first control data signal.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a wireless energy transfer system;

FIG. 2 illustrates a large active array powered and controlled by an active wireless energy transfer system;

FIG. 3 illustrates an active wireless energy transfer system for operating the large active array of FIG. 2;

FIG. 4 illustrates a tap coupler used in the active wireless energy transfer system of FIG. 3;

FIG. 5 illustrates an alternative active wireless energy transfer system including two-way communications for operating the large active array of FIG. 2;

FIG. 6 illustrates a portion of the wireless transfer including a particular one tap coupler and a two-way functional device used in the system of FIG. 5; and

FIG. 7 illustrates a portion of the wireless transfer including a particular one tap coupler and an alternative two-way functional device used in the system of FIG. 5.

### DETAILED DESCRIPTION OF THE INVENTION

Embodiments of the present invention provide a system and method for scaling distributed device arrays, which include displays and sensor arrays. Embodiments of the invention may improve the performance of arrays of virtually all sizes by combining wireless addressing and powering of individual array elements or sub-sectors, groups, or collections of array elements. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “functional device” means broadly an energy dissipating structure that receives energy from an energy providing structure. The term functional device encompasses one-way and two-way structures. In some implementations, a functional device may be component or element of a display.

As used herein, the term “display” means, broadly, a structure or method for producing an image primitive output. The image primitive output are the collection of image constituent signals produced from one or more image primitive precursors. The image primitive precursors have sometimes in other contexts been referred to as a pixel or sub-pixel. Unfortunately the term “pixel” has developed many different meanings so the term image primitive precursor is used herein. An image primitive precursor emits an image constituent signal which is the smallest, most-basic display-related image primitive output component. A signal in this context means a constituent of an image primitive output once the signal is propagated into free space and includes wavefronts that combine with other wavefronts from other signals that are also propagating in free space. A signal has no handedness and does not have a mirror image (that is there is not a reversed, upside-down, or flipped signal while images, and image portions, will have this aspect). Additionally, image portions are not directly additive (overlapping one image portion on another is difficult, if at all possible, to predict a result) and it can be very difficult to process image portions. Some technologies associated with an image primitive precursor implement a system in which the individual image constituent signals are sometimes referred to as a pixel or sometimes as a sub-pixel. For example, in a “red-green-blue” (RGB) system, there are individual precursors for each sub-pixel. For a system that is exclusively an RGB system, there is a correspondence between image primitive precursors and individual structures producing a sub-pixel. However, other technologies do not require a use of sub-pixels and are able to generate a desired output directly from a pixel. In these cases, an image primitive precursor has a correspondence with such pixel generating structures. U.S. patent application Ser. No. 12/371,461, hereby expressly incorporated by reference thereto in its entirety for all purposes, describes systems and methods that are able to advantageously combine such technologies and the term image primitive precursor thus accurately covers the pixel structures for pixel technologies and the sub-pixel structures for sub-pixel technologies. A functional device may include some component or assembly of a display or image primitive precursor.

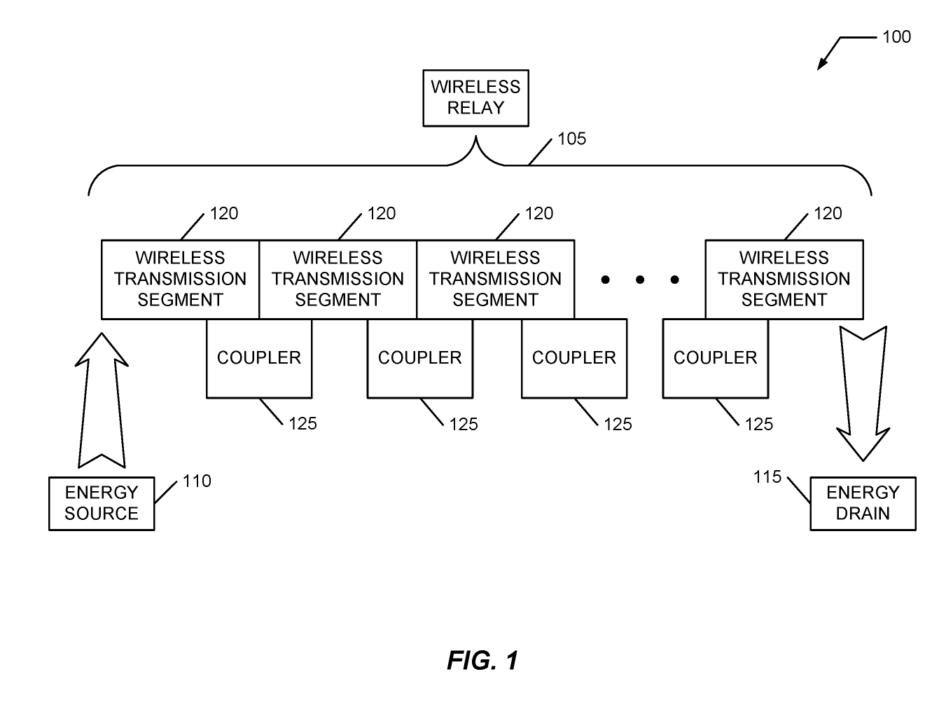

The present application extends and expands some of the teachings of U.S. patent application Ser. No. 15/186,404 which claims benefit of U.S. Patent Application No. 62/181,143 filed 17 Jun. 2015, the contents both of which are expressly incorporated in their entireties for all purposes. The '404 and the '143 application include a discussion of wireless power-relay transmission. One type of disclosed wireless energy transfer system included a series of wireless transmission segments with a coupler provided at interfaces between the segments. The coupler included a regenerator to perform any power and signal conditioning of received energy from one or more upstream segments before transmitting it to one or more downstream segments. Energy from an energy source was wirelessly transmitted through the segments to a remote energy drain. A number of different configurations for couplers and for wireless transmission segments were disclosed. FIG. 1 includes an illustration of a representative configuration of such a wireless energy transfer system. Some embodiments of the present invention may modify such a wireless energy transfer system (or modify other types of wireless transfer systems) for extremely scalable wireless power and addressing of large arrays of functional devices. Different wireless energy transfer systems may be more or less appropriate for different tasks, depending upon design considerations and feature objectives. Bulk power or energy transfer may employ one type of transfer technology and addressing power or energy transfer may employ another type of transfer technology.

For example, one class of large active arrays are used for video display systems. The array includes a grid of discrete video devices that, collectively, produce a composite output from the plurality of discrete devices. A common example is use of an M×N matrix of monitors producing a large aggregated display. Each discrete monitor includes mounting hardware to hold it in its place and separate power lines and signal cables are connected to each discrete monitor. A limitation for extremely large values of M and N includes size, weight, and complexity of the discrete power lines and signal cables, especially in implementations where the signal cables are all sourced from a master controller.

A related but different class of large active arrays includes provision of each display element (e.g., a sub-pixel in an RGB display system or a pixel in alternative display systems that do not include sub-pixels) as a functional device in the array. That is, each display element may be individually wirelessly-powered and/or wirelessly-addressed. In between would be individually wirelessly-powered and/or wirelessly-addressed sub-assemblies of display elements. Each subassembly includes a set of display elements but that set is configured to be less than an entire display device. An entire display device must include two or more sub-assemblies

Also due to such a model, creating a monolithic wall that is structural and incorporates a large seamless matrix of active devices that do not require lines and cables (and management thereof) is challenging. Modification of the wireless power-relay transmission and distance distribution system allows fabrication and use of an extremely scalable large matrix active array. Such an array is not limited to a display system but may incorporate virtually any array of powered and separately addressable functional devices.

The incorporated disclosures include a variety of intermediate couplers that received energy from the one or more upstream segments and transmitted energy to the one or more downstream segments. Energy was input at a head and consumed/terminated at a tail. It was a goal to have the intermediate systems be as lossless as possible to transfer a greatest amount of energy between the head and the tail. Each intermediate coupler included a regenerator for the power and signal conditioning.

Embodiments of the present invention replace one or more of the intermediate couplers with tap couplers. Each tap coupler includes an active regenerator and is coupled to a functional device. The active regenerator may also optionally provide power and signal conditioning for relayed power, but it also includes a controllable energy tap to divert controllably some energy to the coupled functional device. The active regenerator may include a wireless control mechanism in which wireless control data (e.g., optical and/or radiofrequency communications) from a control is able to discretely, individually, and independently control any single active regenerator or a group of active regenerators.

Some arrays may include one or more functional devices that provide one-way energy transfer to a power drain in that their function or role is achieved by receiving power and suitable control. Other arrays may include one or more functional devices that provide two-way energy transfer to a drain and transmission from a source (the functional device acts as both). Sensors and compute-type functional devices are examples of two-way energy transfer functional devices in that they may be powered and addressed remotely and that they also send intelligence (e.g., off-device).

Depending upon the signaling and functional implementation of any given active regenerator, a wireless control signal from a controller may simply provide ON and OFF control signals to an active regenerator to, in turn, cause the coupled functional device to turn ON and turn OFF in response to the control signals. More sophisticated signaling may allow for more complex control options. In some implementations, it may be desired to have an “always on” energy pass-through to relay power from upstream to downstream independent of the control signals received (or not received) by the active regenerator. Other implementations may have a switching pass-through to control relay of energy from the upstream to the downstream.

In the incorporated patent application, the disclosure includes a wide variety of couplers and regenerator implementations. An embodiment of the present invention may include a substitution of one or more active regenerators for the power-relay version of the regenerator (and may include attached functional device(s) and the control mechanism) such as, for example, in any of the intermediate couplers. Illustrated below is but one example for a particular type of wireless energy transfer system.

The incorporated patent application also describes that some portions (or the entirety) of the wireless transfer system may include shielding to improve a coupling efficiency. While shielding may be used in embodiments of the present invention, wireless control signals must be able to be received by the active regenerators.

Some implementations may shift a location of the wireless control receiver to another location or component of the system. For example, some functional devices may include wireless control. It is anticipated that some embodiments will provide a mounting and power interface standard for a functional device and the power, relay, and addressing functions are part of the tap coupler with a standardized interface for any number of types of functional devices. For example, a standard socket may be used for a functional device that is a display system powered and controlled by its associated tap coupler.

In other instances, a functional device may be a subassembly or discrete device that performs an independent function or a collective function in collaboration and synchronization with other functional devices.

As noted herein, a set of functional devices to be controlled may be in a grid. One implementation would be to provide an addressable wireless relay system for each row (or column) of the grid (e.g., wireless power and/or wireless addressing). A single control may be used for all the rows/columns or for a subset thereof.

Functional devices of an active array are not required to be arranged into orderly arrays and matrices. In some cases, it may be desirable to distribute or disperse wirelessly powered and wired functional devices into a substrate or foundation and then use a post-distribution/post-dispersion mapping technique to identify and map particular locations of the functional devices for later operation.

FIG. 1 illustrates a wireless energy transfer system 100. System 100 includes a wireless relay 105 that transfers energy from an energy source 110 to an energy drain 115. Relay 105 includes a series of wireless transmission segments 120 having a coupler 125 at an interface between segments 120. System 100 is designed to transfer energy, or distribute power, from energy source 110 to energy drain 115 through an ambient environment without interaction—in some embodiments this is a targeted one-to-one transfer from energy source 110 to energy drain 115. This is contrast to a range extender or repeater that extends an effective power transfer range to include more devices within the ambient environment around an energy source. Energy source 110 may include one or more sources of energy, including for example line energy from an electrical power distribution grid, and/or stored energy from a battery, ultracapacitor, or the like.

As illustrated, each segment 120 operates using near-field energy coupling that is tailored to maximize energy transfer from a begin node to an end node. Each begin node is designed and intended to be decoupled, within operational parameters and application conditions, from all but one end node of system 100. Further, each end node is designed and intended to be decoupled, within operation parameters and application conditions, from all but one begin node. A wireless transmission technology used by a segment 120 has a limited effective distance, effective in this context refers to a coupling efficiency which affects how much energy is transferred from a begin node to an end node. System 100 includes a set of segments 120 that are designed to wirelessly transfer energy in a one-to-one relationship of begin to end of corresponding nodes. An energy transfer efficiency between non-corresponding nodes is established to be less than a predetermined threshold, that threshold balancing many factors but ultimately effecting an energy transfer throughput of relay 105 when communicating energy from source 110 to drain 115.

Relay 105 is able to effectively use different wireless energy transfer technologies and methodologies, and in some implementations, a hybrid system 100 may include different, but compatible, energy transfer technologies in individual segments 120. Some embodiments include a requirement that, for whatever wireless transfer technology is used, such near-field wireless transfer, there be an intended one-to-one correspondence between a begin node and an end node—the transfer characteristics and parameters effectively, within the desired level of efficiency, communicating energy from the begin node to the end node only.

Couplers 125 provide for an interface between adjacent segments 120 bridging energy communication between them. As illustrated, each coupler 125 includes an end node of an adjacent upstream segment, a regenerator, and a begin node of an adjacent downstream segment. The end node uses a transfer framework compatible with a begin node of a particular adjacent upstream segment (in a case where there are multiple upstream segments) to uniquely receive (i.e., the only intended receiver from a particular node) energy communicated from this begin node. The end node uses a transfer framework compatible with an end node of a particular adjacent downstream segment (in a case where there are multiple downstream segments) to uniquely transmit (i.e., the only intended transmitter to a particular node) energy communicated from this end node. The regenerator, coupled to all the nodes of its coupler 125, receives energy from the end node(s) and processes it for transmission to begin node(s).

For example, in some implementations using non-radiative near-field electromagnetic transfer, resonators are used at each node of each coupler 125. The resonators of corresponding unique pairs of begin and end nodes are designed and selected to interact with each other under resonance conditions. The resonators of non-corresponding pairs of nodes (whether begin and/or end nodes) are designed and selected so that they do not interact with each other, within a level of wireless transfer performance preselected for the system and/or process. A measure of the resonance conditions sometimes employs a coupling coefficient and/or a Q-factor. Some embodiments provide corresponding unique pairs of begin and end nodes with coupling coefficients and/or Q-factors above a transfer threshold for efficient energy transfer between the nodes. Further, some embodiments provide non-corresponding pairs of nodes with coupling coefficients and/or Q-factors below a non-transfer threshold for extremely inefficient energy transfer (if any) between the non-corresponding nodes. System 100 provides for both—highly efficient energy transfer between corresponding unique begin and end node pairs and highly inefficient energy transfer between non-corresponding node pairs, energy transfer pathways from an energy source to an energy drain are defined between a series of successive linked corresponding unique node pairs.

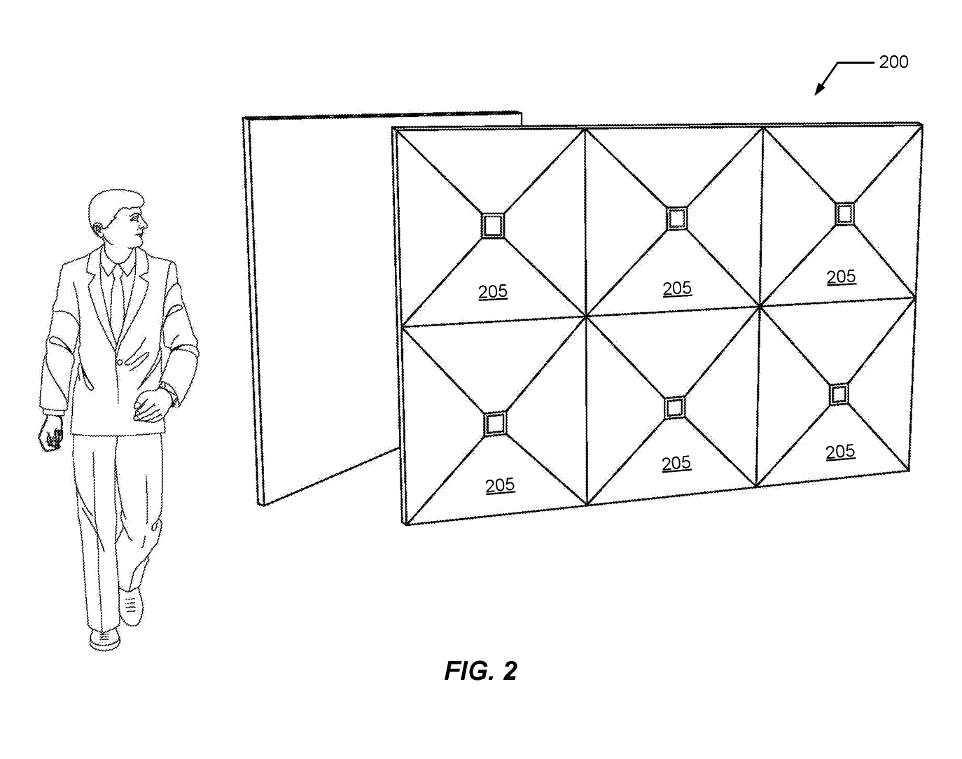

FIG. 2 illustrates a large active array 200 powered and controlled by an active wireless energy transfer system such as described herein. Array 200 may be incorporated into a monolithic wall and include a grid (e.g., 2 rows of 3 columns) of functional devices 205 (e.g., displays, audio system, computing device(s) or other independently addressable and powered device).

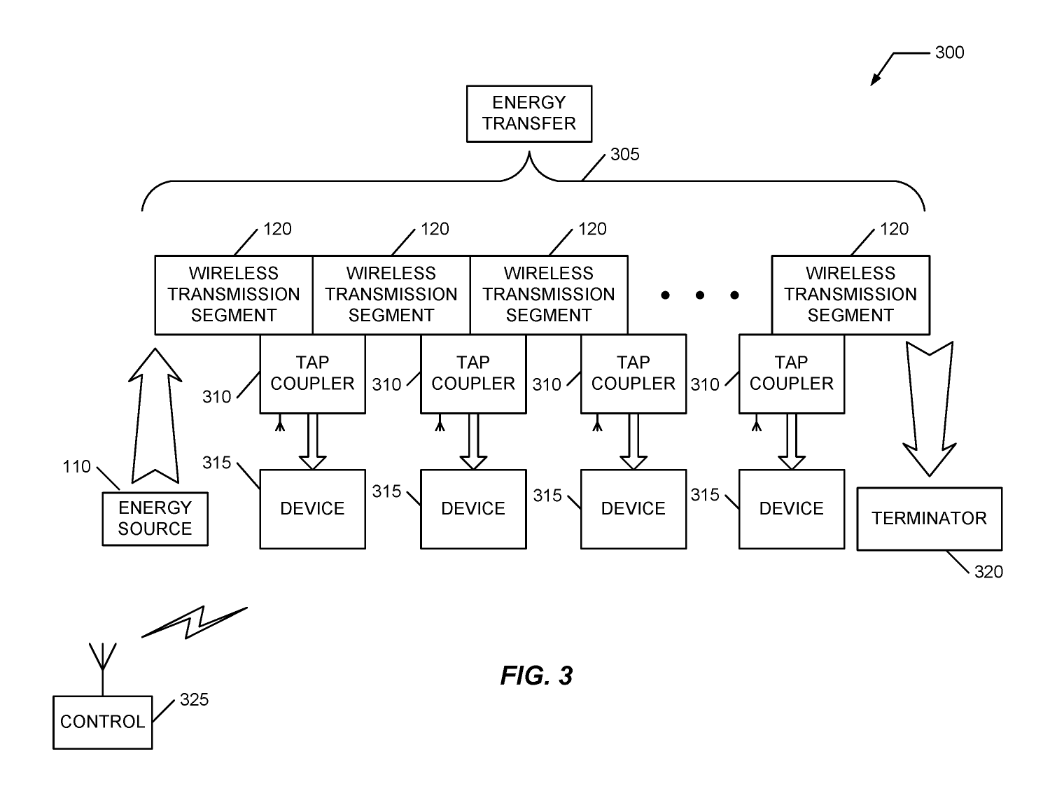

FIG. 3 illustrates an active wireless energy transfer system 300 for operating large active array 200 of FIG. 2. System 300 is similar to system 100 described herein except for explicit modification and contextual changes as noted below. Whereas system 100 had a goal of wirelessly transferring energy/power through a region with minimal energy/power loss, system 300 has a goal of wirelessly infusing/distributing energy/power to functional devices throughout the region of an active array.

System 300 includes an energy transfer 305 having a plurality of tap couplers 310 in place of couplers 105, each tap coupler 310 may be associated with one or more functional devices 315. System 300 does not require energy drain 115 which may be replaced by an optional terminator 320. Terminator 320 may, in some cases, include an additional functional device 315.

For some active arrays, functional devices 315 may require that they receive only power. In such a case, tap couplers 310 collectively power all the functional devices 315 to perform their predetermined operation whenever energy source 110 is active. (Other power transfer systems may distribute power to some type of wireless power receiver in addition to or in lieu of a tap coupler and that power receiver may be coupled to one or more functional devices 310 or integrated into one or more functional devices 315.) However, for many active arrays, it is necessary or desirable to selectively control functional devices 315. That control may be simple (e.g., ON/OFF) or may be more complex. For ON/OFF type control, it may be sufficient to provide for selective addressing of individual tap couplers 310.

System 300 includes a controller 325 that issues command/control signals and data to elements of system 300. For the simple ON/OFF scenario, each tap coupler 310 may be provided with a wireless receiver (illustrated as an antenna) for receipt of wireless transmissions from controller 325. This is an example of simple wireless addressing system.

In other implementations, it may necessary or desirable to move, or add, an addressing receiver to functional devices 315 for command/control selection and designation from controller 325. It is the case that in some embodiments, control receivers are included in some tap couplers 310 as well as in some functional devices 315, and it is not necessary that the control receivers be included in matching/associated coupler/functional device pairs. In some cases, a particular tap coupler 310 may interface to multiple functional devices 315. In other cases, multiple tap couplers 310 may interface to a single functional device 315.

It is also the case that different technologies may be used in different parts of the active array for energy transfer and/or for addressing. That is, some wireless energy transfers may be performed using one technology type and other wireless energy transfers may be performed using another technology type. For example, wireless energy transfer from energy source 110 to tap coupler 310 may be implemented using the Q-coupled resonators as described in the incorporated patent application. Wireless energy transfer from tap coupler 310 to its associated functional device 315 may be performed by a different type of wireless energy transfer, such as beamed radiofrequency transmission.

The wireless addressing needs not to be of the same technology as the technology used for the wireless powering. For example, wireless power transfer may employ Q-coupled resonators while addressing may be performed by a different type of wireless transmission, such as a beamed radiofrequency transmission.

Implementations may sometimes be optimized by having all inter-element power and addressing performed wirelessly. At least in the foreseeable future, at some point electrons will be flowing in circuits and this will require some amount of wiring, (and/or photons routed via waveguides. Waveguides for the purposes of this disclosure be considered a form of “wiring” for photons, and thus included as a sub-case in any reference to “wiring”). Preferably the wiring will be contained with each element. In some instances, it may be necessary or desirable to provide for a partial or whole wiring solution for one of the powering or addressing functions. Some embodiments may thus include a wholly or partially wireless power/energy transfer and a wholly or partially wired addressing mechanism. Other embodiments may thus include a wholly or partially wired power/energy transfer and a wholly or partially wireless addressing mechanism.

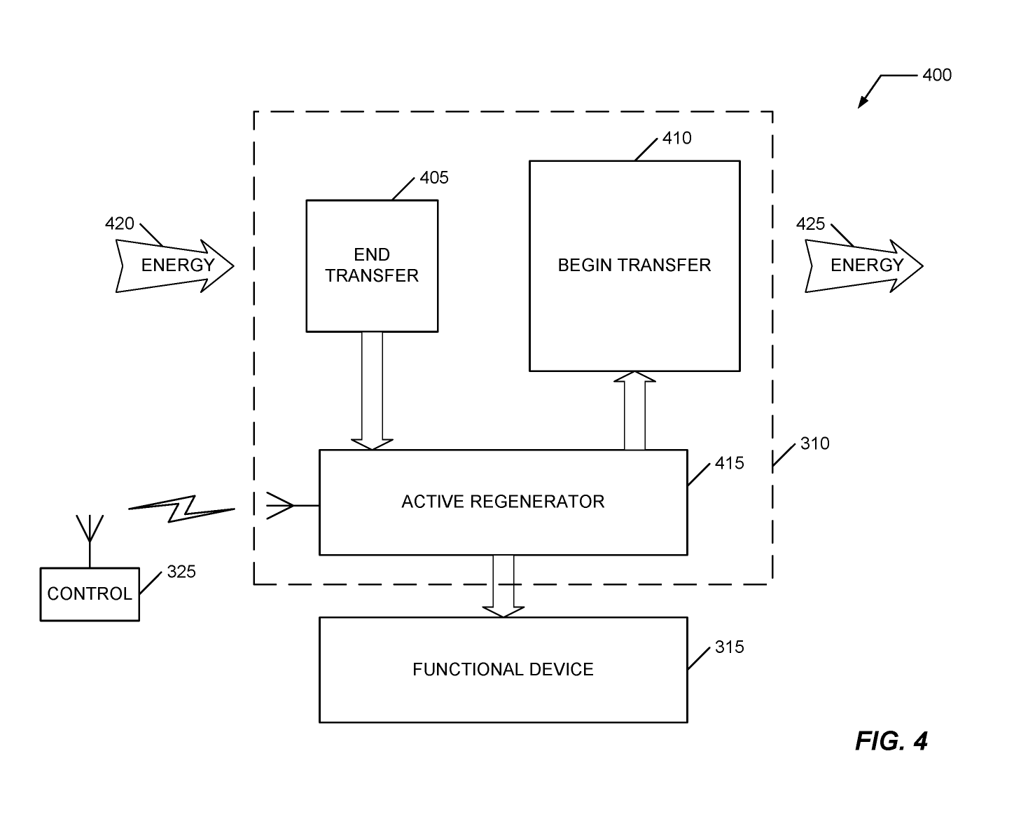

FIG. 4 illustrates a portion 400 of wireless transfer 105 including a particular one tap coupler 310 used in system 300. Tap coupler 310 may include an end transfer node 405, a begin transfer node 410, and an active regenerator 415. Each tap coupler 310 is an interface between an immediately adjacent upstream wireless transmission segment 120 and an immediately adjacent downstream wireless segment 120. End transfer node 405 receives a wireless energy transfer 420 from only a begin transfer node of a particular one immediately adjacent upstream wireless transfer segment 120. End transfer node 405 and the begin transfer node at this interface define a corresponding unique pair of begin and end nodes. End transfer node 405 is compatible with its corresponding uniquely paired begin node such that wireless energy transfer 420 is provided only from the paired begin node and similarly wireless energy transfer from the immediate upstream node is provided only to the corresponding paired end transfer node 405. When the begin transfer node includes a resonator of a particular Q-factor, corresponding end transfer node 405 has a compatible resonator of a matching Q-factor to provide a coupling efficiency at or above the desired transfer efficiency.

Begin transfer node 410 produces a wireless energy transfer 425 at a beginning of the immediately adjacent downstream wireless segment 120. Begin transfer node 410 transmits a wireless energy transfer 425 to only an end transfer node of a particular one immediately adjacent downstream wireless transfer segment 120. Begin transfer node 410 and one end transfer node of this particular one immediately adjacent downstream wireless transfer segment define another corresponding unique pair of begin and end nodes. Begin transfer node 410 is compatible with its corresponding uniquely paired end node such that wireless energy transfer 425 is provided only to the paired end transfer node. Begin transfer node 410 may include a resonator of a particular Q-factor. The uniquely corresponding paired end transfer node may include a compatible resonator of a matching Q-factor to provide a coupling efficiency at or above the desired transfer efficiency. When end transfer node 405 also includes a resonator with a Q-factor, the Q-factor of begin transfer node 310 will have a different Q-factor that provides a coupling efficiency at or below the non-transfer threshold to have no or an extremely inefficient transfer of energy 420 from the begin transfer node.

Active regenerator 415 is coupled to end transfer node 405 to receive energy from wireless energy transfer 420. Active regenerator 315 processes (including conversion, switching, and regulation) this received energy to provide transmission energy to begin transfer node 410 for production of wireless energy transfer 425 and operating energy for an associated functional device 315. Active regenerator 315 is self-contained and is powered from energy received by end transfer node(s) that are part of the same tap coupler 310. A different type of energy transfer technology may power active regenerator 415 with a corresponding different form of a power receiver.

Regenerator 415 is active in that it includes a control receiver for receipt of selection/operating command/control signals and data from controller 325. These command/control signals may be addressing control for operating active regenerator 415. Active regenerator 415 may include one or more operating modes, some of which may additionally respond to additional data input. Controller 325 communicates such command/control signals and any data to the control receiver to select a desired operational mode for active regenerator 415. For example, some commands may determine whether to transfer energy to functional device 315.

In some implementations, active regenerator 415 may continuously transfer power from end transfer node 405 to begin transfer node 410 without information from controller 325. In other implementations, controller 325 may determine whether active regenerator 415 relays energy to coupled downstream segments (and if so, it may also determine how much energy is transferred at any particular time).

As described in the incorporated patent application, command/control information may be communicated to a regenerator using command/control information embedded or otherwise associated with energy transfer 420. Energy transfer between active regenerator 415 and any of its associated functional devices may be performed via wired or wireless communication pathways.

Energy transfer between active regenerator 415 and its associated functional device 315 may be performed via wired or wireless energy transfer. Such wireless energy transfer may employ the same or different wireless energy exchange technology.

Variations in some embodiments may include incorporation of the control receiver into functional device 315. In other embodiments, active regenerator 415 may be integrated with functional device 315.

In operation, energy transfer 420 from an upstream segment is received by an energy receiver (e.g., end transfer node 405). Some of this energy powers active regenerator 415 and its communications circuitry. A control receiver of the communications circuitry receives command/control data from controller 325 for setting an operational mode of active regenerator from available operational modes. Some modes may include an implementation of an addressing schema in which controller 325 individually and discretely controls operation of a particular one active regenerator 415. Other implementations may allow group and system-wide addressing/control of multiple/all active regenerators 415.

In response to the command/control information from controller 325, active regenerator 415 sets operational parameters (among available operational parameters) for its associated functional device 315. These operational parameters are dependent upon the capabilities of any particular type of functional device but may include binary control (e.g., ON/OFF) or analog/digital information for setting values from a range of values in response to the command/control data.

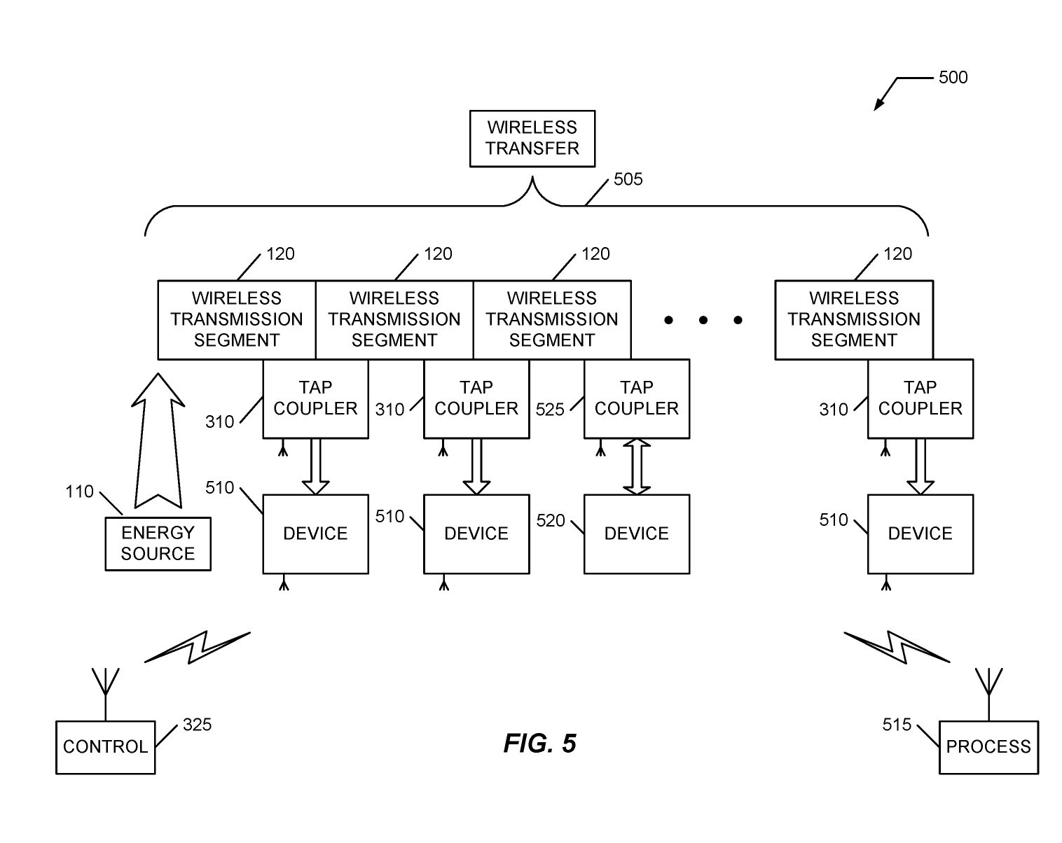

FIG. 5 illustrates an alternative active wireless energy transfer system 500 including two-way communications for operating the large active array of FIG. 2. In system 300 of FIG. 3, functional devices 510 were operated in a “one-way” mode in which energy/power was provided to them. System 500 illustrates a representative “two-way” mode in which energy/power transfer may be provided to and from one or more functional devices 510. As noted herein, there are some types of functional devices in which a user or operator may desire information/data/status from one or more functional devices 510. When a functional device 510 performs some data storage, computation, or sensing role, among other roles, the user/operator may desire access. In such cases, functional devices 510 are provided with two-way communications capability. Two-way communications may be provided in a number of ways, for example a functional device 510 may include a transmit structure to provide its information to a processor 515. The information may be provided autonomously or may be provided in response to command/control information from controller 325.

The command/control information may be received by the control receiver which may, as noted above, be included in either tap coupler 310 and/or functional device 510. The transmit structure of functional device 510 may include a wireless transmission mode to transmit the information directly to processor 515 from a functional device 510. In other implementations, the transmit structure of a functional device 520 may indirectly transmit to processor 515 by sending the information first to its associated tap coupler 525.

Functional device 520 and tap coupler 525 includes some differences as compared, respectively, to functional device 510 and tap coupler 310 to enable tap coupler 525 to directly or indirectly transmit information from functional device 520 to processor 515. For example, a two-way communication exists between functional device 520 and tap coupler 525. Tap coupler 525 may include a transmit structure to send information from functional device 520 directly (e.g., wirelessly without passing through other components of transfer 505) to processor 515. Alternatively, tap coupler 525 may include a transmit structure to send information from functional device 520 indirectly to processor 515. Indirect communication may include a relay through another tap coupler coupled to processor 515 or coupled to a dedicated transmit hub (which may be one type of functional device for an array including two-way functional devices).

For example, for every N-number of two-way functional devices 510 or functional device 520, a transmit hub functional device may be included to relay transmit information from these devices to processor 515. Functional devices 510 may wirelessly communicate directly to the transmit hub which would then relay (directly or indirectly) the information to processor 515. Functional devices 520 may directly communicate (wirelessly or wired) with its associated tap coupler 525 for relay (direct or indirect) to the transmit hub which in turn relays (direct or indirect) the information to processor 515.

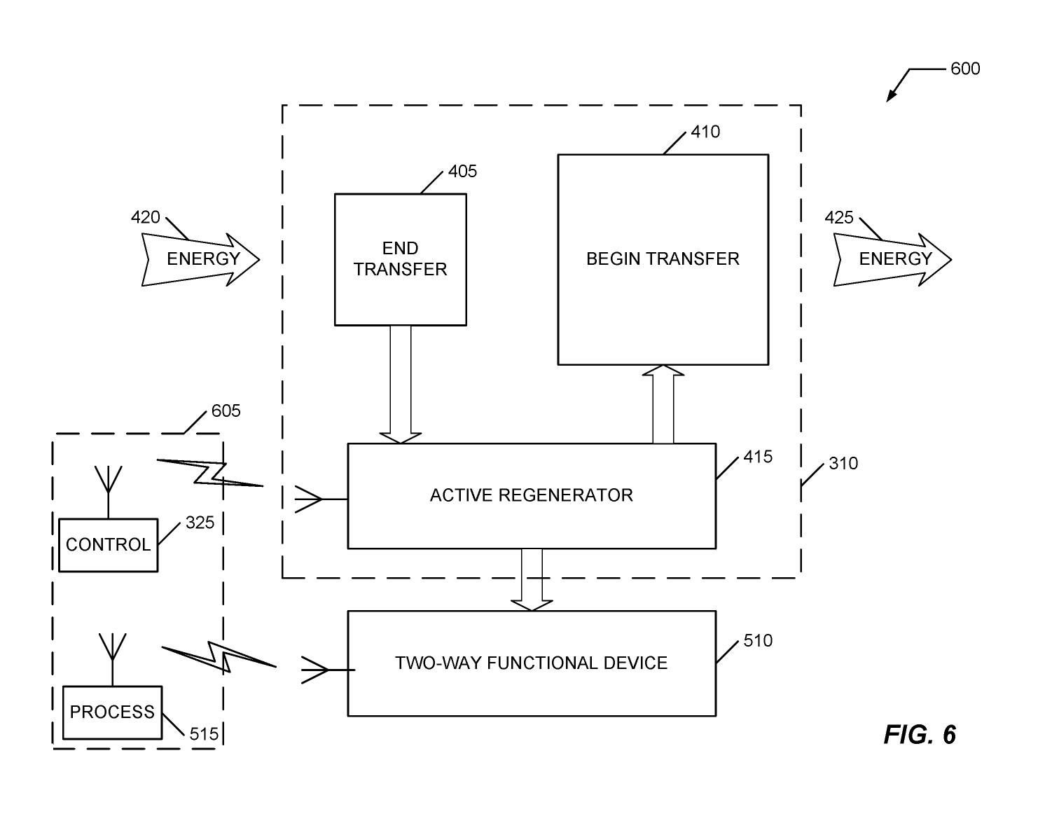

FIG. 6 illustrates a portion 600 of wireless transfer 105 including a particular one tap coupler 310 and functional device 510 used in system 500. Portion 600 generally conforms to portion 400 as modified for two-way communications with respect to functional device 510. As illustrated in the example of FIG. 6, operating energy is provided to two-way functional device 510 from a tap of energy transfer 420. Any command/control for two-way functional device 510 may be provided from controller 325, such as, for example, relayed through associated active regenerator 415. Information from two-way functional device 510 may be provided directly to processor 515 from a transmit structure included with two-way functional device 510. As illustrated, controller 325 and processor 515 may be combined (operationally, functionally, and/or structurally) into a single master unit 605.

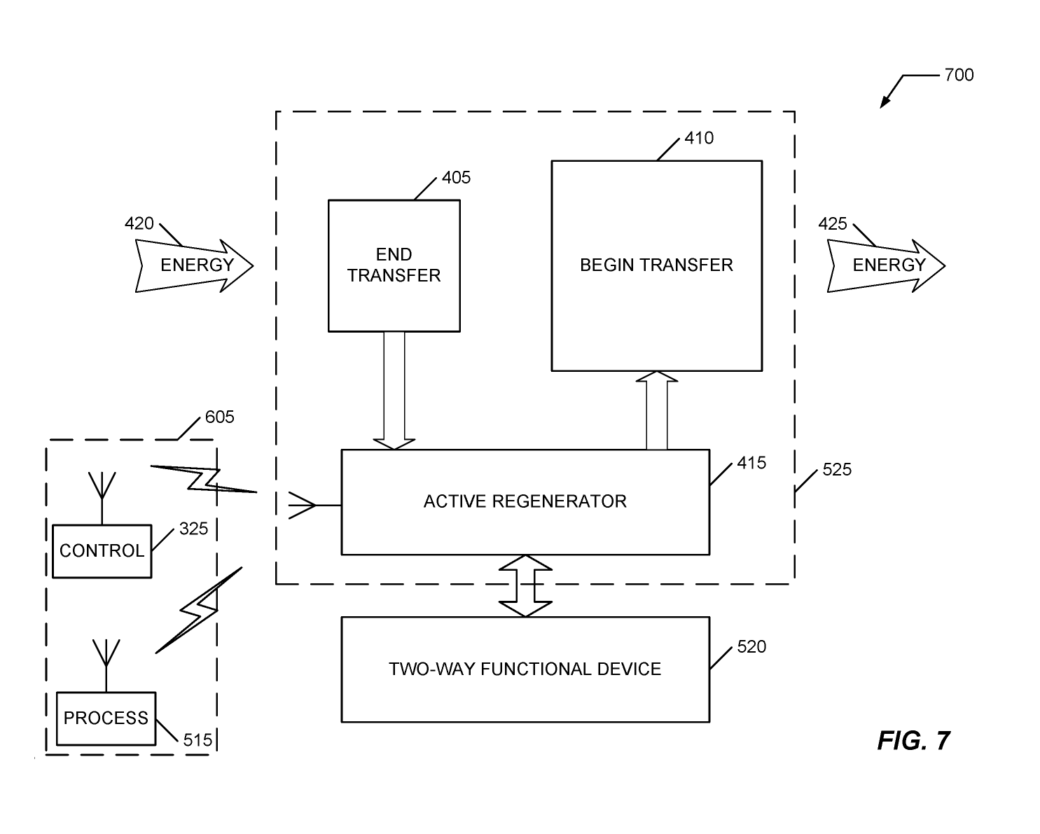

FIG. 7 illustrates a portion 700 of wireless transfer 105 including a particular one tap coupler 525 and associated alternative two-way functional device 520 used in system 500. Portion 700 generally conforms to portion 400 and portion 600 as modified for alternative two-way communications with respect to functional device 520. As illustrated in the example of FIG. 7, operating energy is provided to two-way functional device 520 from a tap of energy transfer 420. Any command/control for two-way functional device 510 may be provided from controller 325, such as, for example, relayed through associated active regenerator 415. Information from two-way functional device 520 may be provided indirectly to processor 515 from a transmit structure included with associated active regenerator 415.

One-way and two-way systems and methods having N number of functional devices may include an energy source in a first “stage” directly coupled to all N functional devices as the last “stage” of the embodiment. In other embodiments, one or more intermediate stages may be included between the first and last stages of some or all of the N number of functional devices to provide a “fan out” of energy and/or addressing distribution. In one-way or two-way implementations, some embodiments may include one or more of the functional devices as distribution hubs for wired/wired distribution of energy and/or addressing.

Wireless addressing and powering of arrays or networks of micro devices, nano-devices, or hubs which in turn power and address micro or nano-devices, represents a significant change in power and addressing technology for large distributed arrays since the advent of the first flat-screen displays, addressed by row-and-column passive and active circuit grids.

Elimination of power and addressing circuitry, beyond the relatively tiny lengths of circuitry required for each local node, not only eliminates the obvious weight and bulk of the circuitry—a major benefit to any display technology such as LCD, gas-plasma, or OLED—but eliminate a major drain on power, reduction in switching speed, and source of heat which must be itself managed by cooling solutions, which of course require even more power. Cost of manufacturing can be substantially reduced, especially for very large arrays, and large arrays will be enabled that are relatively impractical or totally impractical otherwise based on current technologies.

In addition, some embodiments of the proposed invention of the present disclosure may be particularly suited to and compatible with many systems and methods. For example, some implementations may include textile-structured devices, including woven display and sensor arrays, which are structurally and manufacturing-wise ideally-suited to implement and integrate of arrays and networks wirelessly addressed and powered devices.

Wireless addressing and powering of array elements or sub-sectors, groups or collections of array elements are most effectively employed in conjunction, but may also be employed individually.

Power and signal “relay” systems may be employed to transfer power and addressing across an array, as opposed to power and signal being distributed from one central hub.

Multiple hubs may also be addressed by “hard-wire,” as well as connected wirelessly from a central hub. Combinations of hard-wire and wireless hubs are also contemplated.

Preferred methods of wireless addressing may include a novel device building on the foundation of miniature RFID devices and circuits, taking advantage of new methods of highly-miniaturized, cheap RFID chip manufacturing technology that matches device dimensions of individual elements of distributed arrays, including the dimensions of display subpixels and micro-sensors.

Preferred methods of wireless powering may include a wireless-relay system employing alternating sequences of low-frequency emitter-resonators.

Other wireless transmitter-receiver methods, both those currently known to the art and future types, may be employed and are contemplated to be compatible with embodiments of the invention of the present disclosure, both for addressing arrays of devices and for powering those arrays.

In a modified RFID method of addressing an individual array element or hub (which then addresses a subsector of an array, preferably wirelessly, but alternatively by hard-wire), a RFID-type device and circuit is paired with another device (individual array element, such as a subpixel, pixel or sensor, or a hub-device controlling other such devices), such that when the receiving antenna circuit element of the RFID-type device receives a signal from the RFID-type transmitter containing an identifier data element that matches an identifier data element in the RFID-type device's memory, the RFID-type device or circuit sends a signal to the device with which it is paired to perform an operation.

Such operations might include turning a pixel or sensor on or off, or setting the level or other characteristic(s) of a pixel or sensor or other device.

Optionally, as is similar to the function of a conventional RFID, an antenna circuit element may send a signal back to the originating or other RFID-type device to confirm that it has performed that operation, or if there is an error, and it will be tagged with the same unique identifier to confirm which RFID-type node device is responding.

Multiple RFID-type transmitters (or other wireless data transmitters) may be employed by an array processing unit to simultaneously transmit addressing or operation information to subsets of array elements, in a parallel processing model.

In the manufacturing of a distributed array of this fashion, RFID-type devices coupled with operative nodes in the array (individual elements or hubs) may be pre-programmed with unique identifiers and then located one-by-one spatially in a pre-determined pattern.

This, however, will typically require a more laborious, costly and error-prone manufacturing method.

Thus, preferably, and as an additional benefit of some embodiments of the proposed invention, a unique set of pre-programmed RFID-type devices (coupled with operative nodes) may be more or less randomly distributed across an area or throughout a volume. More than one such RFID-operative device(s) pair may in fact be co-located spatially.

Once the array is fabricated and the RFID-operative device(s) are manufactured and spatially distributed across an array structure, a next step to “map” the spatial location of the devices may be employed. Many forms of “readers” may be employed, that either move sequentially over a surface or through a volume (multiple readers requiring volumetric reading), or reading or mapping an entire array at the same time, and then analyzing the capture space in software. Within each RFID-type device either the RFID itself may return its unique value as an RF-signal, or the operative device (such as a sub-pixel) may be commanded to perform an operation or sequence of operations that may be imaged or “read.”

Another preferred method of solving the problem of physically-deploying RFID-operative device pairs or groups executes the programming of the RFID-type device after it is spatially deployed in an array. Variants on this method include sequentially moving over the array and transmitting signal to one RFID-type device at a time, by virtue of low power and/or directionality-close proximity, and assigning a unique identifier data element to each RFID-type device. Alternatively, in a sensor array, the operative sensor device may be employed in a programming scheme, such that the setting of the RFID-type device's unique identifier is performed by receipt of non-RF signal by the operative sensor. Combinations of RF and sensor signals may also be employed, and distributed arrays combining sensors and emitters (display pixels or sub-pixels, for instance) thus allow for combinations of post-manufacturer programming of the RFID-type devices in the array.

RFID-type devices have not only seen major advances in cost reduction per-chip, and smaller-and-smaller sizes, but technical challenges such as shielding and management of directionality of signal have been addressed by a number of innovations, all of which benefit the proposals of the present disclosure.

Among commercial innovators, Hitachi has been a leader, and has announced multiple breakthroughs in RFID technology miniaturization in the past decade, beginning in 2003 through 2007, (from the Nikkei Electronics website www.techon.nikkeibp.co.jp, Feb. 20, 2007):
At ISSCC 2007, Hitachi, Ltd. and Renesas Technology Corp. have delivered a lecture (lecture number 26.6) about their micro RFID tag (wireless tag) IC measuring only 0.05×0.05×0.005 mm. This is as small as 2/27 their “next-generation mu-chip” measuring 0.15×0.15×0.0075 mm announced at the preceding ISSCC in 2006. This IC was manufactured using 90-nm CMOS technology using SOI substrates. It features a three-layer metal wiring layer and a 21×32 μm memory chip capable of recording 128-bit data. It is attached to a separately-provided external antenna when used, and communicates with the RFID tag reader via the 2.45 GHz band. Maximum communication range is 300 mm. Mitsuo Usami, Senior Chief Researcher at Hitachi's Central Research Laboratory who delivered the lecture, said its power when transmitting data is “slightly less than 1 mW.”

More recently, on Sep. 10, 2012, Hitachi announced a commercial product in a standalone package (RFID Journal):
Hitachi Chemical is marketing an EPC Gen 2 passive ultrahigh-frequency (UHF) RFD tag that is one of the smallest tags on the market, measuring just 2.5 millimeters (0.098 inch) square and 0.3 millimeter (0.012 inch) thick. Consisting of an Impini Monza 5 chip and an antenna embedded in epoxy resin, the Ultra-Small Package tag is designed to be durable enough that it could be applied via injection molding or incorporated into printed circuit boards.

RFID reader ranges may extend, in long-range versions, to the hundreds of meters. An example of such is commercially available from Sky RFID, the SKYR433SLH Ultra Long Range Serial Fixed Reader has a range of 200 meters, which may be boosted to 500 meters.

An example of a shorter range all-in-one UHF reader/writer is one available from GAO RFID Inc., model 216010, with a read/write range of 15 m.

When referring to “RFID,” it is also understood that the basic principle of wireless reading/writing is not frequency-dependent. Thus, shorter or longer frequencies for either reading and/or writing are encompassed within the scope of the present disclosure for wireless addressing or any reading/writing of arrays of devices functioning at least in a part as a related complex of devices in a system.

It is also an essential provision of some embodiments of the present disclosure that it proposes addressing (or reading/writing) arrays of devices or more than one device in a spatial arrangement, fixed or dynamic, that exist as part of a system, rather than in the case of conventional RFID, which is defined as the reading and/or writing to a discrete device, whether located near other discrete devices or not, which do not function in any system together, either fixed or temporary. It is a wireless tagging and identification technology for identifying discrete tags and was conceived and defined in that context, again as opposed to addressing (reading/writing) of devices in a collection which are functionally and/or spatially differentiated from each other, whether in fixed or changing position, location or orientation.

Nano-antennas and micro-cavities, as reported in work such as that reported by Feuillet-Palma, Todorov, Vasanelli, and Sirtori in “Strong near field enhancement in THz nano-antenna arrays,” (Scientific Reports 3, Article number: 1361 doi:10.1038/srep01361, 1 Mar. 2013), demonstrate the progress in further miniaturization of antenna structures at shorter frequencies, with cavity lengths of 12 microns and widths of 3 microns. Even greater progress has been reported in the work of Sun, Timurdogan, Yaacobi, Hoseini & Watts in “Large-scale nanophotonic phased array,” Nature 493, 195-199 (10 Jan. 2013) Published online 9 Jan. 2013, with a compact optical nano-antenna structure as part of the functional “cell” measuring 3×2.8 microns (the entire cell, with the emission components, measures 9×9 microns).

Previously, “passive” RFID technology, such as LFID, could not be expected to provide enough power to both power the addressing function and the operative function of the array element. Fortunately, there are improved methods of wireless power transmission/coupling, which are proposed as elements of the wireless power-relay system of the present disclosure. Improvements in nano-antenna efficiencies, such as those lines of development cited here, offer further pathways for even greater net efficiencies.

Wireless power transmission was first proposed and realized, in a wide variety of forms, by Nikola Tesla, as exemplified in U.S. Pat. No. 645,576 System of Transmission of Electrical Energy and U.S. Pat. No. 649,621, Apparatus for Transmission of Electrical Energy, described new and useful combinations of transformer coils. The transmitting coil or conductor arranged and excited to cause currents or oscillation to propagate through conduction through the natural medium from one point to another remote point therefrom and a receiver coil or conductor of the transmitted signals. The production of currents of very high potential could be attained in these coils.

More recently, wireless RF power transmission to light-bulb devices, marking a further application and development of the Tesla approach, have been proposed (U.S. Pat. No. 6,476,565), in which the RF-power is absorbed by gas in the bulb or coatings on the inside of the glass which are chosen with properties “tuned” to absorb RF and re-emit in another frequency, to produce visible light. Additional materials, as employed in certain forms of “white light” LED lighting may be used to further re-emit to realize a particular color or a balanced white illumination.

Even more recently, wireless “charging” (power coupling of a connected power-device to a portable-mobile device via magnetic fields, for instance) is now commercially available from Splashpower, and proposed in U.S. Pat. Nos. 6,906,495 and 7,042,196.

Some embodiments of the present disclosure may be adapted for use with wireless RF illumination methods for individual pixel-back illumination elements in a display device.

While Tesla worked with a great range of frequencies, more recent work has either been at frequencies which are too high to be transmitted safely at high energies over distances, or which can (magnetic induction) only operate over very short distances. Splashpower is a commercially-available version of this technology.

An example of a Tesla-inspired product using safe low-frequencies for wireless charging of portable devices has been proposed and realized by Joannopolous, Karalis, and Soljacic of MIT, as disclosed in pending US Patent Application 20070222542. A range of resonator sizes were modeled and realized, using the well-known Maxwell's and related mathematical equations from the field of physics, which demonstrated relatively high-power through relatively large distances between (and through walls) of a building. Power delivered in this system is highly efficient, and at least 1000 times as efficient as non-resonant induction coupling.

The basis of this method, resonant induction, is in placing a resonant object in the near-field (non-traveling) magnetic field of a resonator; evanescent wave coupling. This is different from the much more familiar non-resonant induction methods employed by Splashpower and others.

The following is an example of a possible implementation of an embodiment of the present invention which realizes not a simple device-battery charger system but a complete, efficient wireless power distribution/relay system through the modules of the intelligent structural system, and enabling of wireless power distribution and access to other devices and systems which may not be “part” of an intelligent structural system, is described as follows:

An external electrical power connection, either external to a building structure and connected directly to at least a portion of a building which is an intelligent structure, or within a building which is traditionally hard-wired to a portion of that building which is an intelligent structure.

The alternating or direct electrical current is then fed to a near-field generation element, preferably a magnetic field resonator with a particular Q factor. This resonator, to minimize the use of electrical wiring or other conventional conductive material which conducts electrons and electrical power on or in its body, is preferably located on the outer edges of a module, and furthermore, preferably in a location of the module out of the em-transfer path for display, lighting, and sensing, although the magnetic field generating resonator may itself be substantially or partly be fabricated of a transparent or substantially transparent conductive material.

Within the same module, depending on its size, or between smaller modules (noting an experimental success in the usage of paired resonator of 5 m+), one or more resonators with a second Q factor are placed, but these resonators are further married and electrically connected to another resonator with a third Q factor. The multiple resonator-pairs are distinct from the first resonator, which receives power from an external electro-motive force (typically, as noted, an external power line). The Q-factors are calculated using methods known to the art, as exemplified by the published work of Joannopoulos, Karalis, and Soljacic, and the improved devices they propose include feedback mechanisms to modify Q in an individual device to account for other potentially absorbtive objects in the path of resonant emission. Research has shown, coupling time for the resonator and resonant receiver are faster than the time it takes a potentially absorptive object to draw-off. This has allowed demonstration of efficient transmission through walls.

Wire loops and dielectric disks have both been employed as resonant structures. Folded-loops with the same resonant frequency provide a path well-known to the art of antenna engineering for implementing extremely compact resonators. Resonators may be designed for power transfer to autonomous nano-objects, and device features which will be required to fabricate such compact resonators can now be fabricated by various methods known to the art, including emboss-etch and other technologies.

The multiple resonator-pairs may be seen as power-relay pairs, which if the contact is open between the receiving and the re-emitting pair, provides at least portion of the input power to the output device.

Spatially, the input resonator is closer in orientation to the distant original resonator than the relay resonator; optimally, the relay pair is placed within the efficient coupling distance of the first emitter.

From the position of the original resonator, with respect to the module in which it is placed, a sphere may be understood to define a shape of the resonant field emitted by the resonator. Depending on the use of impermeable material around the resonator, this shape may be modified and tailored. But at progressive distances from the emitter, relay-pairs may be placed, where wireless power-relay paths may be desired, and pairs will be positioned to optimally receive the resonant field energy.

To implement an actual “relay” system, if no impermeable material is employed as a “shield” or any other field-shaping means is employed to avoid “crosstalk” with respect to the potentially multiple relay-pairs with respect to an original resonator, another type of relay-pair is needed, which is at a distance from any of the first type of relay pairs, and typically at a greater distance than that from the original resonator, and placed with respect to one or more of the first type of relay-pair to optimally receive the resonant energy from one or more re-emitters.

This third type of component is a relay-pair which combines a receiving resonator with a fourth Q factor and a re-emitting resonator with either the first Q factor, or a fifth Q-factor. If a fifth Q-factor, then a fourth type of relay-pair is needed, which consists of a sixth Q-factor receiver and the first Q-factor re-emitter.

The principle determining whether additional types of relay-pairs are needed is the degree to which a re-emitter will “short-circuit” the power-relay system by being bled off from an earlier receiver on the “line.” Thus, a borderline arrangement places at least one intervening, different relay-pair, between the first resonator and another re-emitting resonator with the same Q-factor, in a system with four Q-factors. Depending on materials, such an arrangement will require either magnetically impermeable shielding materials and/or field-shaping structures.

Preferably, therefore, there are sets of four elements in a line, counting an original, externally-powered resonator, and three if the original emitter is not counted.

The other devices in the intelligent system thus preferably each retain at least one, and in practice, multiple receiving-resonant structures to allow them to receive one or more frequencies of resonant field energy as transmitted by the multiple types of emitters and re-emitters, with multiple Q-factors. Each and any of these resonators are preferably also actually switchable circuits, i.e., that a critical portion of the resonant structure may be removed by either mechanical, acoustic, electrical, magnetic, electro-optic, magneto-optic, acousto-optic, or other methods known to the art which can “switch” and make resonantly-inoperative at least some sufficiently large portion of the resonator to change its Q and resonant frequency.

The power-relay devices, as is preferable with other devices deployed and distributed in the proposed intelligent structure, are preferably wirelessly addressed as well. Thus, an intelligent system can determine whether any power should be emitted at all from the original emitter, and if so, which relay nodes or power distribution vectors, intra and inter-module, should be switched “on.”

Non-volatile memory within these addressable, wirelessly-powered devices, to be accessed by a wireless addressing (preferably RFID as detailed herein, but also Bluetooth, Wi-Fi, Wi-Max, 3G, and the like) signal, which may also provide the input energy to power the circuit which tells the device to complete the circuit for the receiving-resonators.

Of course, in the case of wirelessly-addressed and powered hubs, the same scheme may be employed, with lower power levels and shorter distances employed to power and address individual devices.

The combination of wirelessly-addressing and powering of distributed arrays will enable array scaling to wall, room and building size, and beyond, such that the definition of an “array” will be expanded to blur into “network.” Leveraging the processing capacity of cheap, distributed microprocessors in display and sensor arrays as part of large networks will add overall computing and Internet switching capacity if designed to allow usage of that capacity. Arrays thus become akin to server-farms, and software may be optimized to utilize the latent capacity of nodes in large arrays, and cheap and plentiful nodes themselves can be augmented in their processing and storage capacity to provide greater contribution to computing and telecommunications tasks.

Some of the disclosed embodiments may include elements and components such as one or more antennae and/or one or more ring resonators (e.g., split ring resonator). These elements and devices may be fabricated in very small scale, for example, at a nano-scale. These and other anticipated advances in fabrication techniques and miniaturization are anticipated to possibly further enhance manufacture and use of various embodiments of the present invention. For example, the following articles provide some representative references illustrating recent design and fabrication of such components: “An ultrathin invisibility skin cloak for visible light” by Xingjie N I, et al. in Science, 18 Sep. 2015, Vol. 349, no. 6254 pp. 1310-1314, “All-Dielectric Optical Nanoantennas” by Alexander E. KRASNOK, et al., Chapter 6, pp. 143-175 of PROGRESS OF COMPACT ANTENNAS, InTech, 10 Sep. 2014, and “WIDEBAND PLANAR SPLIT RING RESONATOR BASED METAMATERIALS” by Abdolshakoor RIGI-TAMANDANI, et al., Progress in Electromagnetics Research M, Vol. 28, 115-128, 2013, the contents in their entireties are hereby expressly incorporated by reference thereto for all purposes.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A wireless energy transfer system for transferring energy from an energy source to an energy drain, comprising a wireless relay including a plurality of serially coupled wireless transmission segments defining a set of interfaces between pairs of said wireless transmission segments and a coupler disposed at each said interface of said set of interfaces, wherein each said coupler includes a begin energy transfer node having a begin wireless transfer coupling value, an end energy transfer node having an end wireless transfer coupling value different from said begin wireless transfer coupling value configured to be non-interactive within a predetermined level of wireless transfer performance with said begin wireless transfer coupling value, and a regenerator coupled to both said nodes, wherein said set of interfaces includes two or more interfaces, and wherein at least one of said couplers includes a first tap coupler having a first controllable energy access, said first tap coupler diverting energy from said regenerator to said first controllable energy access responsive to a first control data signal.

2. The system of claim 1 wherein said first control data signal includes a first wireless control data signal and wherein said first tap coupler includes first wireless receiver receiving said first wireless control data signal.

3. The system of claim 1 further comprising a controller communicated to said first tap coupler wherein said controller provides said first control data signal for selective energy diversion from said first controllable energy access.

4. The system of claim 2 further comprising a wireless controller communicated to said first tap coupler wherein said wireless controller provides said first wireless control data signal for selective energy diversion from said first controllable energy access.

5. The system of claim 1 wherein said first tap coupler includes a first address and wherein said first tap coupler is responsive only to said first control data signal when it is associated with said first address.

6. The system of claim 2 wherein said first tap coupler includes a first address and wherein said first tap coupler is responsive only to said first wireless control data signal when it is associated with said first address.

7. The system of claim 3 wherein said first tap coupler includes a first address and wherein said first tap coupler is responsive only to said first control data signal when it is associated with said first address.

8. The system of claim 4 wherein said first tap coupler includes a first address and wherein said first tap coupler is responsive only to said first wireless control data signal when it is associated with said first address.

9. The system of claim 1 further comprising a second tap coupler having a second controllable energy access, said second tap coupler diverting energy from said regenerator to said second controllable energy access responsive to a second control data signal.

10. The system of claim 9 wherein said second control data signal is different from said first control data signal.

11. The system of claim 10 wherein said first control data signal includes a first wireless control data signal, wherein said second control data signal includes a second wireless control data signal, wherein said first tap coupler includes first wireless receiver receiving said first wireless control data signal, and wherein said second tap coupler includes second wireless receiver receiving said second wireless control data signal.

12. The system of claim 10 further comprising a controller communicated to said tap couplers wherein said controller provides said control data signals for selective energy diversion from said controllable energy accesses.

13. The system of claim 11 further comprising a wireless controller communicated to said tap couplers wherein said wireless controller provides said wireless control data signals for selective energy diversion from said controllable energy accesses.

14. The system of claim 10 wherein said first tap coupler includes a first address, wherein said second tap coupler includes a second address different from said first address, wherein said first tap coupler is responsive only to said first control data signal when it is associated with said first address, and wherein said second tap coupler is responsive only to said second control data signal when it is associated with said second address.

15. The system of claim 11 wherein said first tap coupler includes a first address, wherein said second tap coupler includes a second address different from said first address, wherein said first tap coupler is responsive only to said first wireless control data signal when it is associated with said first address, and wherein said second tap coupler is responsive only to said second wireless control data signal when it is associated with said second address.

16. The system of claim 12 wherein said first tap coupler includes a first address, wherein said second tap coupler includes a second address different from said first address, wherein said first tap coupler is responsive only to said first control data signal when it is associated with said first address, and wherein said second tap coupler is responsive only to said second control data signal when it is associated with said second address.

17. The system of claim 13 wherein said first tap coupler includes a first address, wherein said second tap coupler includes a second address different from said first address, wherein said first tap coupler is responsive only to said first wireless control data signal when it is associated with said first address, and wherein said second tap coupler is responsive only to said second wireless control data signal when it is associated with said second address.

18. The system of claim 13 wherein said first tap coupler includes a first address, wherein said second tap coupler includes said first address, wherein said first tap coupler is responsive only to said first wireless control data signal when it is associated with said first address, and wherein said second tap coupler is responsive only to said second wireless control data signal when it is associated with said first address.

19. The system of claim 18 wherein said second wireless control data signal includes said first wireless control data signal.

20. The system of claim 9 wherein said second control data signal is the same as said first control data signal.

21. The system of claim 20 wherein said first control data signal includes a first wireless control data signal, wherein said second control data signal includes a second wireless control data signal, wherein said first tap coupler includes first wireless receiver receiving said first wireless control data signal, and wherein said second tap coupler includes second wireless receiver receiving said second wireless control data signal.

22. The system of claim 21 further comprising a controller communicated to said tap couplers wherein said controller provides said control data signals for selective energy diversion from said controllable energy accesses.

23. The system of claim 22 further comprising a wireless controller communicated to said tap couplers wherein said wireless controller provides said wireless control data signals for selective energy diversion from said controllable energy accesses.

24. The system of claim 1 wherein said first tap coupler is configured to couple to a first functional device having a first functional energy access having a first electrical communication to said first controllable energy access.

25. The system of claim 24 wherein said first functional device selectively receives energy from said first tap coupler via said first electrical communication.

26. The system of claim 24 wherein said first functional device selectively transmits energy to said first tap coupler via said first electrical communication.

27. The system of claim 25 wherein said first functional device selectively transmits energy to said first tap coupler via said first electrical communication.

28. The system of claim 25 wherein said first functional device includes a first active radio-frequency identification (RFID) tag powered through said first electrical communication.

29. The system of claim 9 wherein said first tap coupler is configured to couple to a first functional device having a first functional energy access having a first electrical communication to said first controllable energy access and wherein said second tap coupler is configured to couple to a second functional device different from said first functional device having a second functional energy access having a second electrical communication to said second controllable energy access.

30. The system of claim 29 wherein said first functional device selectively receives energy from said first tap coupler via said first electrical communication and wherein said second functional device selectively receives energy from said second tap coupler via said second electrical communication.

31. The system of claim 29 wherein said first functional device selectively transmits energy to said first tap coupler via said first electrical communication and wherein said second functional device selectively transmits energy to said second tap coupler via said second electrical communication.

32. The system of claim 30 wherein said first functional device selectively transmits energy to said first tap coupler via said first electrical communication and wherein said second functional device selectively transmits energy to said second tap coupler via said second electrical communication.

33. The system of claim 30 wherein said first functional device includes a first active radio-frequency identification (RFID) tag powered through said first electrical communication and wherein said second functional device includes a second active radio-frequency identification (RFID) tag powered through said second electrical communication.

34. The system of claim 1 wherein said wireless relay includes a first upstream segment having a first begin energy transfer node coupled to the energy source, said first begin energy transfer node having a first begin wireless transfer coupling value, wherein said wireless relay includes a first downstream segment at a first interface with said first upstream segment, wherein said first interface includes a first coupler having a first end energy transfer node having said first begin wireless transfer coupling value, and wherein said first coupler includes a second begin energy transfer node having a second begin wireless transfer coupling value different from said first begin wireless transfer coupling value configured to be non-interactive within a predetermined level wireless transfer performance with said first begin wireless transfer coupling value.

35. The system of claim 34 wherein said wireless relay includes a second upstream segment that includes said first downstream segment with said second upstream segment including said second begin energy transfer node having said second begin wireless transfer coupling value, wherein said wireless relay includes a second downstream segment at a second interface with said second upstream segment, wherein said second interface includes a second coupler having a second end energy transfer node having said second begin wireless transfer coupling value, and wherein said second coupler includes a third begin energy transfer node having a third begin wireless transfer coupling value different from said second begin wireless transfer coupling value configured to be non-interactive within a predetermined level wireless transfer performance with said second begin wireless transfer coupling value.

36. The system of claim 35 wherein said wireless relay includes a third upstream segment that includes said second downstream segment with said third upstream segment including said third begin energy transfer node having said third begin wireless transfer coupling value, wherein said wireless relay includes a third downstream segment at a third interface with said third upstream segment, wherein said third interface includes a third coupler having a third end energy transfer node having said third begin wireless transfer coupling value, and wherein said third coupler includes a fourth begin energy transfer node having a fourth begin wireless transfer coupling value different from said third begin wireless transfer coupling value configured to be non-interactive within a predetermined level wireless transfer performance with said third begin wireless transfer coupling value.

37. The system of claim 34 wherein said first downstream segment includes a second end energy transfer node having said second begin wireless transfer coupling value, said second end energy transfer node coupled to the energy drain.

38. The system of claim 35 wherein said second downstream segment includes a third end energy transfer node having said third begin wireless transfer coupling value, said third end energy transfer node coupled to the energy drain.

39. The system of claim 36 wherein said third downstream segment includes a fourth end energy transfer node having said fourth begin wireless transfer coupling value, said fourth end energy transfer node coupled to the energy drain.

40. The system of claim 1 wherein said wireless relay is configured for a near-field energy transfer architecture, wherein each said node includes a resonator, and wherein each said wireless transfer coupling value includes a Q-factor.

41. The system of claim 34 wherein said wireless relay is configured for a near-field energy transfer architecture, wherein each said node includes a resonator, and wherein each said wireless transfer coupling value includes a Q-factor.

42. The system of claim 35 wherein said wireless relay is configured for a near-field energy transfer architecture, wherein each said node includes a resonator, and wherein each said wireless transfer coupling value includes a Q-factor.

43. The system of claim 36 wherein said wireless relay is configured for a near-field energy transfer architecture, wherein each said node includes a resonator, and wherein each said wireless transfer coupling value includes a Q-factor.

44. The system of claim 39 wherein said wireless relay is configured for a near-field energy transfer architecture, wherein each said node includes a resonator, and wherein each said wireless transfer coupling value includes a Q-factor.

45. The system of claim 1 wherein said wireless relay includes a first upstream segment having a first begin energy transfer node, said first begin energy transfer node having a first begin wireless transfer coupling value, wherein said wireless relay includes a first downstream segment at a first interface with said first upstream segment, wherein said wireless relay includes a second downstream segment at a second interface with said first upstream segment, wherein said first interface includes a first coupler having a first end energy transfer node having said first begin wireless transfer coupling value, wherein said first coupler includes a second begin energy transfer node having a second begin wireless transfer coupling value different from said first begin wireless transfer coupling value configured to be non-interactive within a predetermined level wireless transfer performance with said first begin wireless transfer coupling value, and wherein said first coupler includes a third begin energy transfer node having a third begin wireless transfer coupling value different from said first begin wireless transfer coupling value configured to be non-interactive within a predetermined level wireless transfer performance with said first begin wireless transfer coupling value with said third begin energy transfer coupling value different from said second begin wireless transfer coupling value configured to be non-interactive within a predetermined level wireless transfer performance with said second begin wireless transfer coupling value.

46. The system of claim 1 wherein said wireless relay includes a first upstream segment having a first begin energy transfer node, said first begin energy transfer node having a first begin wireless transfer coupling value, wherein said wireless relay includes a second upstream segment having a second begin energy transfer node, said second begin energy transfer node having a second begin wireless transfer coupling value different from said first begin wireless transfer coupling value configured to be non-interactive within a predetermined level wireless transfer performance with said first begin wireless transfer coupling value, wherein said wireless relay includes a first downstream segment at a first interface with said first upstream segment and with said second upstream segment, wherein said first interface includes a first coupler having a first end energy transfer node having said first begin wireless transfer coupling value, wherein said first coupler includes a second end energy transfer node having said second begin wireless transfer coupling value, and wherein said first coupler includes a third begin energy transfer node having a third begin wireless transfer coupling value different from said first begin wireless transfer coupling value configured to be non-interactive within a predetermined level wireless transfer performance with said first begin wireless transfer coupling value with said third begin energy transfer coupling value different from said second begin wireless transfer coupling value configured to be non-interactive within a predetermined level wireless transfer performance with said second begin wireless transfer coupling value.

47. The system of claim 1 wherein said wireless relay includes a first upstream segment having a first begin energy transfer node, said first begin energy transfer node having a first begin wireless transfer coupling value, wherein said wireless relay includes a second upstream segment having a second begin energy transfer node, said second begin energy transfer node having a second begin wireless transfer coupling value different from said first begin wireless transfer coupling value configured to be non-interactive within a predetermined level wireless transfer performance with said first begin wireless transfer coupling value, wherein said wireless relay includes a first downstream segment at a first interface with said first upstream segment and with said second upstream segment, wherein said first interface includes a first coupler having a first end energy transfer node having said first begin wireless transfer coupling value, wherein said first coupler includes a second end energy transfer node having said second begin wireless transfer coupling value, wherein said first coupler includes a third begin energy transfer node having a third begin wireless transfer coupling value different from said first begin wireless transfer coupling value configured to be non-interactive within a predetermined level wireless transfer performance with said first begin wireless transfer coupling value with said third begin energy transfer coupling value different from said second begin wireless transfer coupling value configured to be non-interactive within a predetermined level wireless transfer performance with said second begin wireless transfer coupling value, and wherein said first coupler includes a fourth begin energy transfer node having a fourth begin wireless transfer coupling value different from said first begin wireless transfer coupling value configured to be non-interactive within a predetermined level wireless transfer performance with said first begin wireless transfer coupling value with said fourth begin energy transfer coupling value different from said second begin wireless transfer coupling value configured to be non-interactive within a predetermined level wireless transfer performance with said second begin wireless transfer coupling value with said fourth begin energy transfer coupling value different from said third begin wireless transfer coupling value configured to be non-interactive within a predetermined level wireless transfer performance with said third begin wireless transfer coupling value.

48. A method for transferring wirelessly energy from an energy source to an energy drain, comprising:
a) energizing a first set of begin energy transfer nodes, each said begin energy transfer node including a begin wireless transfer coupling value;
b) energizing, responsive to said energization of said first set of begin energy transfer nodes, a first set of end energy transfer nodes, each said end energy transfer node having an end wireless transfer coupling value wherein each particular single one energized end energy transfer node is energized by a single one energized begin energy transfer node having a begin wireless transfer coupling value matching said end wireless transfer coupling value of said particular single one energized end energy transfer node within an interaction range;
c) transferring energy from the energy source coupled to a specific begin energy transfer node to the energy drain coupled to a specific end energy transfer node;
wherein said wireless relay includes a set of a plurality of energized begin energy transfer nodes within said interaction range of each said energized end energy transfer nodes with all energized begin energy transfer nodes other than said single one energized begin energy transfer node of said set of said plurality of energized begin energy transfer nodes each having a begin wireless transfer coupling value different from said begin wireless transfer coupling value of said single one energized begin energy transfer node; and
wherein said wireless relay includes a set of a plurality of energized end energy transfer nodes within said interaction range of each said energized begin energy transfer nodes with all energized energy transfer nodes other than said single one energized end energy transfer node of said set of said plurality of energized end energy transfer nodes each having an end wireless transfer coupling value different from said end wireless transfer coupling value of said single one energized end energy transfer node; and
wherein at least one of said couplers includes a first tap coupler having a first controllable energy access, said first tap coupler diverting energy from said regenerator to said first controllable energy access responsive to a first control data signal.
